(19) United States
(12) Patent Application Publication
(10) Pub. No.: US 2024/0401689 A1
(43) Pub. Date: Dec. 5, 2024

(54) HOUSING FOR AN ELECTROMECHANICAL DISC BRAKE ACTUATOR COMPRISING A DAMPING ELEMENT

(71) Applicant: HITACHI ASTEMO FRANCE, Drancy (FR)

(72) Inventors: Nicolas Briane, Trelaze (FR); Benoit De Champeaux, Aubervilliers (FR)

(21) Appl. No.: 18/262,767

(22) PCT Filed: Jan. 25, 2022
(86) PCT No.: PCT/FR2022/050134

§ 371 Date: Jul. 25, 2023

(30) Foreign Application Priority Data
Jan. 26, 2021 (FR) 2100709

(51) Int. Cl. F16H 57/028; F16D 65/18; F16D 121/24; F16H 57/02; F16H 57/031

(52) U.S. Cl. CPC F16H 57/028; F16D 65/18; F16H 57/031; F16D 2121/24; F16H 2057/02034; F16H 2057/02082

(57) ABSTRACT

A housing for an electromechanical actuator, the housing comprising an open face on which a cover is mounted for closing an opening of the open face, the housing including damping elements associated with the cover and positioned between the cover and the housing. A disc brake caliper and a disc brake includes such a housing for an electromechanical actuator.

### TECHNICAL FIELD

The present invention relates to the general field of motor vehicle disc brakes, and more particularly relates to a motor vehicle disc brake of the electromechanical type, i.e. comprising an electromechanical actuator for pressing one or more brake pad(s) against the disc in order to generate braking.

More specifically, the invention relates to one or more covers for an electromechanical actuator case which is mounted on the case body so as to limit the transmission of vibrations towards the cover(s).

### PRIOR ART

Referring to FIG. 1, an example of a caliper body 1 of an electromechanical disc brake has been represented in perspective. Moreover, FIG. 2 represents, in an exploded view, an example of an electromechanical actuator 7 intended to equip such a caliper.

As shown in FIG. 1, the caliper body 1 includes a base 2 extended by an arch 4, itself extended by fingers 6. The base 2 includes a case in which a movable piston is engaged to press a brake pad, not represented, onto a brake disc. This base 2 also encloses in the rear region of the piston a movement transformation mechanism with helical connection, to convert a rotational movement into a translational movement of the piston, which corresponds to converting a force moment into a pressing force.

This caliper body 1 is further equipped with an electromechanical actuator 7 to act on the piston so as to press the pad against the disc, on activation of this actuator 7. This actuator 7 comprises a case 8, or casing, having a fastening face 9, shown in FIG. 2, by which it is intended to be coupled to the caliper body 1, and an opposite face 11 closed by a cover 12. The fastening face 9 and the opposite face 11 are faces that are substantially planar and parallel to each other.

In addition, as shown in FIG. 2, the fastening face 9 includes a main portion surrounding an opening 28 forming a centring. The fastening face 9 of the case 8 is further applied against the base 2 of the caliper body 1, which is an entirely planar surface.

The case 8 encloses different components forming a motor-drive assembly 13 coupled to a mechanical reducer 14 which allows moving the piston when this reducer 14 is coupled to the caliper body 1, i.e. when the actuator 7 is fastened to the base 2. The reducer 14 drives two planetary gear trains 18. The motor-drive assembly 13 includes an electric motor 19 having an output pinion 20.

As shown in FIG. 2, the elements of the reducer 14 rotate about axes parallel to the axis of rotation AM of the motor 19. In the example of the figures, the axis AM is parallel to a main axis AX which corresponds to the axis of translation of the piston when the actuator 7 is mounted on the caliper body 1, this axis AX extending transversely with respect to the vehicle equipped with the brake.

When the actuator 7 is mounted, the motor 19 is in place in the cavity corresponding to the opening 24, and the pinion 20 drives a single toothed wheel (not represented). The planetary gear train 18 includes a coupling element 27, for example of the Torx™ type, which opens into a corresponding opening 28 of the fastening face 9, to drive the movement transformation mechanism accommodated in the base 2.

Moreover, besides the electromechanical means for moving the piston, the caliper also includes hydraulic means for moving the piston. In this case, the electromechanical means ensure the movement of the piston in the case of parking and/or emergency braking, and the hydraulic means ensure movement thereof in case of service braking.

Conventionally, the cover 12, which closes the opposite face 11 of the case 8 of the electromechanical actuator 7, is fastened directly on the case 8 of the electromechanical actuator.

Thus, the vibrations that are produced by the motor-drive assembly 13 and the reducer 14 are transmitted directly to the cover 12. When vibrating, the cover 12 then produces a relatively high noise.

The object of the invention is to provide a case of an actuator which is designed so as to limit the overall noise produced by the electromechanical actuator DISCLOSURE OF THE INVENTION

Hence, the invention relates, according to one of its aspects, to an electromechanical actuator case including an open face and on which said open face, a cover is mounted to close an opening of said face, [0015] characterised in that it includes vibration damping means associated to the cover.

In particular, these damping means allow reducing the amplitude of the vibrations of the cover, which originate from the case. As the vibrations of the cover are consequently lower, the generated noise is consequently also reduced.

Preferably, said damping elements are compressed between the case and the cover.

Preferably, the case includes two damping elements distributed symmetrically with respect to a median main axis of the cover.

Preferably, each damping element extends according to a vertical main direction and includes a lower section which is received in an associated housing of the case and an upper section which is received in an associated housing of the cover.

Preferably, each section of a damping element is compressed horizontally in the housing associated thereto.

Preferably, each damping element is compressed according to the vertical direction by the cover and the case.

Preferably, each housing of the cover and of the case includes a bottom against which a vertical end of the damping element bears vertically.

The invention also relates to an electromechanical actuator for a motor vehicle disc brake caliper, which includes a case according to the invention.

The invention also relates to a motor vehicle disc brake caliper, which includes an electromechanical actuator according to the invention.

The invention also relates to a motor vehicle disc brake, characterised in that it includes a caliper according to the invention.

### BRIEF DESCRIPTION OF THE DRAWINGS

FIG. 1 is a perspective overview, of an electromechanical brake caliper body represented alone.

FIG. 2 is an exploded overview of an electromechanical actuator intended to equip a caliper.

FIG. 3 is a sectional view of an actuator similar to that represented in FIGS. 1 and 2, showing the damped connection between the case and the cover.

FIG. 4 is a schematic perspective representation of a damper installed between the case and the cover in FIG. 3.

FIG. 5 is a schematic perspective representation of the cover on which two dampers are mounted.

FIG. 6 is a schematic perspective representation of the case on which two dampers are mounted.

### DETAILED DESCRIPTION OF THE INVENTION

In the following description, identical, similar or analogous elements will be referred to by the same reference numerals.

The longitudinal, vertical, transverse orientation according to the reference frame V, L, T indicated in the figures will be used, wherein the vertical orientation is the orientation parallel to the axes AM and AX, the longitudinal orientation is the main direction of the cover 12 and the transverse orientation is parallel to the plane of the cover 12, along its width.

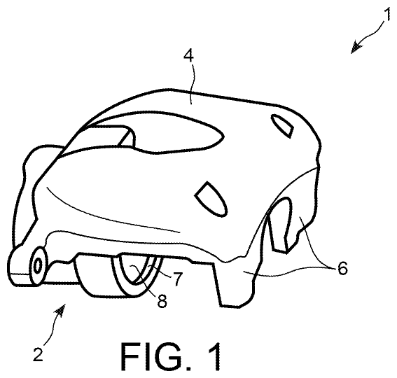

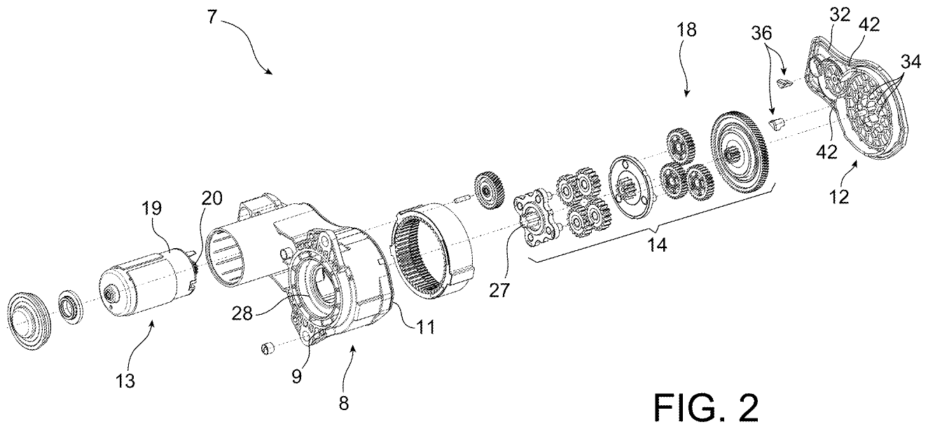

FIGS. 1 and 2 have already been described before in the part relating to the prior art and to the technical context of the invention. It should be noted that the features specific to the caliper body 1, to the case 8 and to the electromechanical actuator 7, in particular their constituent elements, are not herein described again, only the features specific to the cover 12 being explained. Nonetheless, the case 8, the electromechanical actuator 7 and the brake calliper in accordance with the invention may include any one of these features, alone or in combination, described before with reference to FIGS. 1 and 2.

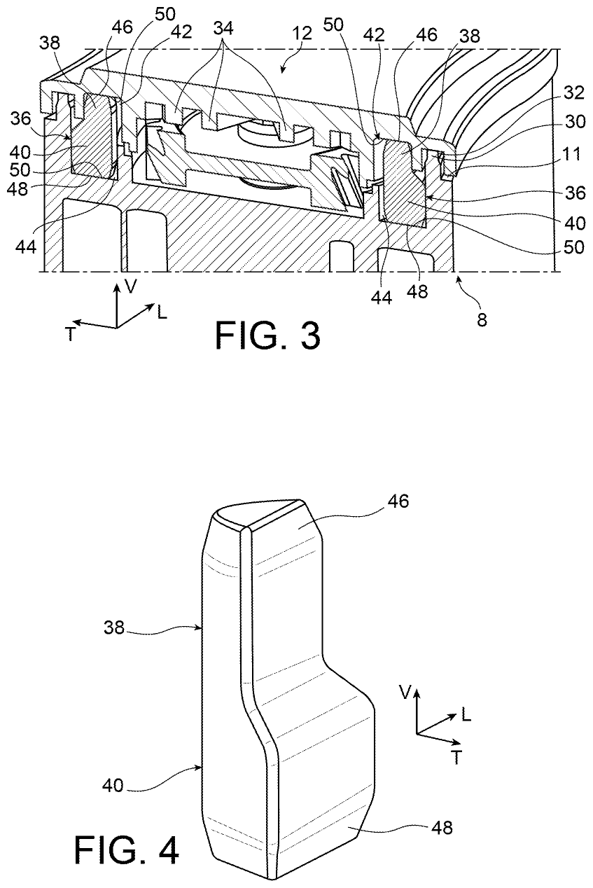

Referring to FIG. 3 et seq., a preferred embodiment of the connection between the case 8 and the cover 12 will be described.

As mentioned before, the case 8 includes an open face 11, on which a cover 12 is mounted.

In order to guarantee a good sealing and a good positioning of the cover 12 with respect to the face 11 of the case, a rib 30 extends projecting from the face 11, over the entire periphery thereof.

The rib 30 is received in an associated groove 32 of the cover 12.

As mentioned before, during the operation of the actuator 7, vibrations are produced by the motor-drive assembly and are transmitted to the cover 12.

The cover 12 then vibrates like a membrane, it also vibrates in torsion around its longitudinal main axis.

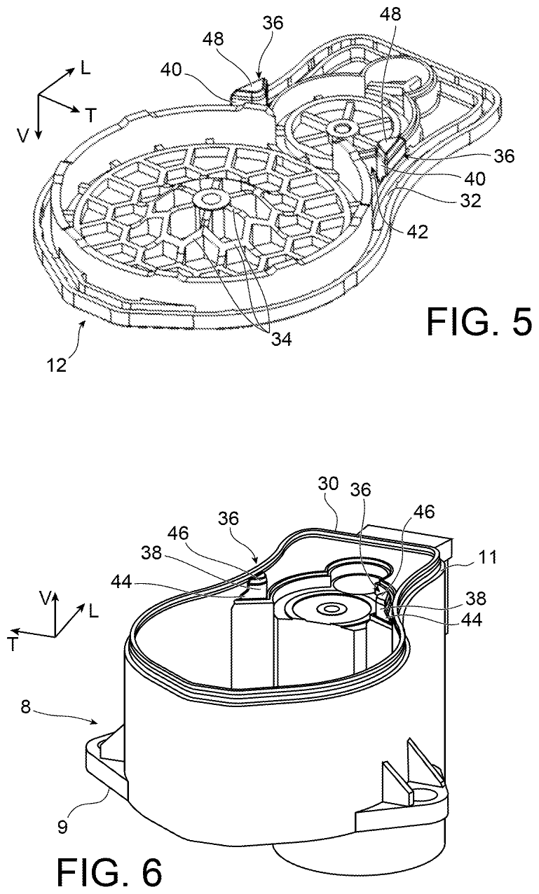

To limit these vibrations, as shown in FIG. 5, the cover includes ribs 34, forming for example a so-called honeycomb hexagonal structure.

To complete the effect of these ribs, damping elements 36 are joined to cover 12, thereby limiting its vibrations.

The damping elements 36 are compressed between the cover 12 and the case 8, thereby producing a bearing on the cover 12 and damping the vibrations thereof.

Herein, according to a preferred embodiment, two damping elements 36 are mounted between the case 8 and the cover 12.

The damping elements 36 are distributed symmetrically with respect to a median vertical longitudinal plane of the cover 12.

Each damping element 36 is made of an elastic material such as an elastomer, which provides it with viscoelastic and/or shear damping AV of at least some of the vibrations to which it is subjected.

The damping elements 36 are disposed at locations in which they do not interfere with the other components of the actuator 7.

As shown in more detail in FIG. 4, each damping element 36 has a vertical main orientation and it includes an upper section 38 which cooperates with the cover 12 and a lower section 40 which cooperates with the case 8.

The cover 12 includes a housing 42 which is associated to each damping element and in which the upper section 38 of the associated damping element 36 is received.

According to a preferred embodiment, the upper section 38 of the damping element 36 is compressed horizontally by the walls of the housing 42 when it is received in this housing 42.

This state is obtained by the fact that the dimensions of the upper section 38 are larger than those of the housing 42 when the upper section 38 of the damping element 36 is not mounted in the housing 42.

To facilitate the insertion of the upper section 38 of the damping element 36 into the housing 42, its free upper end 46 is chamfered, as shown in FIG. 4.

Similarly, the case 8 includes a housing 44 which is associated to each damping element 36 and in which the lower section 40 of the damping element 36 is received.

According to a preferred embodiment, the lower section 40 of the damping element 36 is compressed horizontally by the walls of the housing 44 of the case 8 when it is received in this housing 44.

This state is obtained by the fact that the dimensions of the lower section 40 are larger than those of the housing 44 when the lower section 40 of the damping element 36 is not mounted in the housing 44 of the case 8.

According to one variant, in the context of a damping of the viscoelastic type AV, each damping element 36 has a volume substantially equal to that of the corresponding housings 42, 44. Thus, each damping element 36 is received in each housing 42, 44 with stress over at least one portion of the surface of the walls of said corresponding housings 42, 44.

To facilitate the insertion of the lower section 40 of the damping element 36 into the housing 44, its free lower end 48 is chamfered, as shown in FIG. 4.

Each damping element 36 is also compressed vertically between the case 8 and the cover 12.

This vertical compression causes an additional horizontal deformation of the damping element 36 in the associated housings 42, 44 of the cover 12 and of the case 8.

To ensure the vertical compression of each damping element 36, each of the associated housings 42, 44 includes a bottom wall 50 on which an associated vertical end 46, 48 is placed bearing vertically when the cover 12 is mounted on the case 8.

The use of such damping elements 36 allows limiting the amplitude of the vibrations producing noise, without having to modify the cover 12, or the case 8.

Indeed, the housings 42, 44 intended to receive the damping elements may be housings already present on the cover 12 and the case 8, the shapes and dimensions of the damping elements 36 are then determined according to the shapes and dimensions of the housings 42, 44 intended to receive the damping elements 36.

According to the embodiment represented in the figures, the two damping elements 36 have similar shapes and are disposed symmetrically with respect to a median longitudinal axis of the cover 12.

Besides damping the vibrations of the cover 12 like a membrane, this arrangement allows damping the vibrations of the cover 12 in torsion about this median longitudinal axis of the cover 12.

It should be understood that the invention is not limited to this embodiment and that the damping elements 36 could be disposed in the actuator 7 at other locations and/or in a non-symmetrical manner.

### NOMENCLATURE

1 caliper body
2 base
7 electromechanical actuator
4 arch
6 fingers
8 case
9 fastening face
11 opposite face
12 cover
28, 24 opening
13 motor assembly
14 mechanical reducer
18 planetary gear train
19 electric motor
20 output pinion
21, 22 electronic boards
23 plate
27 coupling element
30, 34 ribs
32 groove
36 damping element
38 upper section
40 lower section
42, 44 associated housings
46 free upper end
48 free lower end
50 bottom wall.

What is claimed is:

1. A case for an electromechanical actuator including an open face and on which said open face, a cover is mounted to close an opening of said open face,
the case further including damping elements associated to the cover interposed between the cover and the case,
each damping element extends according to a main vertical direction and includes a lower section which is received in a housing associated to the case and an upper section which is received in an associated housing of the cover.

2. The case according to claim 1, wherein said damping elements are compressed between the case and the cover.

3. The case according to claim 1, wherein it includes two damping elements symmetrically distributed with respect to a middle main axis of the cover.

4. The case according to claim 1, wherein each section of a damping element is compressed horizontally in the housing associated thereto.

5. The case according to claim 1, wherein each damping element is compressed according to the vertical direction by the cover and the case.

6. The case according to claim 5, wherein each housing of the cover and of the case includes a bottom against which a vertical end of the damping element bears vertically.

7. An electromechanical actuator for a motor vehicle disc brake caliper, wherein it includes a case according ton claim 1.

8. A motor vehicle disc brake caliper, wherein it includes an electromechanical actuator according to claim 7.

9. A motor vehicle disc brake, wherein it includes a caliper according to claim 8.
